(19) United States
(12) Patent Application Publication
(10) Pub. No.: US 2024/0336854 A1
(43) Pub. Date: Oct. 10, 2024

(54) PRODUCTION OF FUEL HAVING RENEWABLE CONTENT FROM A LOW CARBON NUMBER FRACTION

(71) Applicant: Iogen Corporation, Ottawa (CA)

(72) Inventor: Patrick J. Foody, Ottawa, Ontario (CA)

(21) Appl. No.: 18/578,697

(22) PCT Filed: Jun. 26, 2022
(86) PCT No.: PCT/CA2022/051026

§ 371 Date: Jan. 11, 2024

Related U.S. Application Data
(60) Provisional application No. 63/203,278, filed on Jul. 15, 2021.

(51) Int. Cl. C10G 49/00; C01B 3/34

(52) U.S. Cl. CPC C10G 49/007; C01B 3/34; C01B 2203/0233; C01B 2203/0405; C01B 2203/062; C10G 2300/1033

(57) ABSTRACT

Disclosed is a method for producing a fuel that has renewable content, the method comprising: providing renewable hydrogen sourced at least partially from causing renewable methane from a low carbon number fraction resulting from a conversion process to be fed, or co-fed with fossil material, to a hydrogen production unit to produce the renewable hydrogen, the feed to the conversion process being a carbon-containing renewable feedstock, the low carbon number fraction comprising carbon-containing molecules having 3 carbon atoms or less, the conversion process from which the hydrogen is sourced comprising a separation that fractionates the low carbon number fraction from a high carbon number fraction comprising carbon-containing molecules having 3 carbon atoms or more; and feeding the renewable hydrogen to at least part of a fossil fuel production facility to supply the renewable hydrogen thereto and produce the fuel that has renewable content.

### TECHNICAL FIELD

The present invention generally relates to a method and/or system for producing one or more fuels using renewable methane, and more specifically, to a method and/or system for producing one or more fuels in a fuel production process that includes methane reforming of a gas containing renewable methane.

### BACKGROUND

Steam methane reforming (SMR) is a common pathway to supply hydrogen. In conventional steam methane reforming, natural gas (NG) is exposed to a catalyst at high temperature and high pressure, thereby promoting a catalytic reaction wherein methane (CH₄) and steam are converted to carbon monoxide (CO) and hydrogen (H₂) according to the following reaction.

CH₄+H₂O+heat⇄CO+3H₂ (1)

Additional hydrogen can be obtained by reacting the carbon monoxide with water in a water gas shift (WGS) reaction to form carbon dioxide and more hydrogen, as follows.

CO+H₂O→CO₂+H₂+small amount of heat (2)

A hydrogen production unit typically includes one or more reactors configured to promote these reactions and produce syngas. The term “syngas” refers to synthesis gas, which is a gas mixture that contains varying amounts of hydrogen (H₂) and carbon monoxide (CO), and often some carbon dioxide (CO₂). A hydrogen production unit typically also includes a purification system to remove carbon oxide impurities (e.g., by pressure swing adsorption) to provide a relatively pure hydrogen product.

Hydrogen is increasingly used in the production of fuels (e.g., liquid transportation fuels). For example, hydrogen is used in oil refineries in the hydroprocessing of crude oil and/or crude oil derived liquid hydrocarbon (e.g., to produce fuels such as gasoline, jet fuel, and diesel). In U.S. Pat. Nos. 8,658,026, 8,753,854, 8,945,373, 9,040,271, 10,093,540, 10,421,663, and 10,723,621, and 10,981,784, Foody discloses a method of producing fuel in which renewable hydrogen hydrogenates crude oil derived liquid hydrocarbon. In this approach, gasoline, diesel, and/or jet fuel having renewable content can be produced using existing fuel production facilities (e.g., an oil refinery). The term “renewable content”, as used herein, refers the portion of the fuel or fuels produced, that is recognized and/or qualifies as renewable (e.g., a biofuel) under applicable regulations.

There is an ongoing need to further promote the use of renewable energy to speed the transition to a greener economy.

### SUMMARY

In one embodiment, the present disclosure may provide a process for producing a fuel having renewable content in existing fuel production facilities (e.g., an oil refinery) by sourcing and/or producing renewable hydrogen from a low carbon number fraction produced during a conversion process that uses a carbon-containing feedstock that is renewable. Such process may advantageously enable the use of a low carbon number fraction, often simply vented or used to produce heat and/or power, to instead make a fuel having renewable content in an existing fossil fuel production facility. Sourcing hydrogen in this manner may incentivize the use of renewables by using existing infrastructure and/or fossil fuel production facilities to produce a fuel having renewable content. Alternate and further embodiments are described herein.

In one aspect, there is provided a method for producing a fuel that has renewable content, the method comprising providing renewable hydrogen, the renewable hydrogen sourced at least partially from causing renewable methane from a low carbon number fraction resulting from a conversion process to be fed, or co-fed with fossil material, to a hydrogen production unit to produce the renewable hydrogen, wherein a feed to the conversion process is a carbon-containing renewable feedstock, wherein the low carbon number fraction comprises carbon-containing molecules having 3 carbon atoms or less, and wherein the conversion process from which the renewable hydrogen is sourced comprises a separation that fractionates the low carbon number fraction from a high carbon number fraction comprising carbon-containing molecules having 3 carbon atoms or more; and using the renewable hydrogen as feedstock at a fossil fuel production facility to produce the fuel that has renewable content.

In one embodiment of the foregoing aspect, the hydrogen production unit is located at the fossil fuel production facility. In another embodiment of the foregoing aspect, the hydrogen production unit is located off-site of the production facility.

According to the foregoing aspect or embodiment, the conversion process from which the hydrogen is sourced uses bio-methane, bio-oil, bio-ethanol or biomass as a feedstock.

According to the foregoing aspect or embodiments, the method may further comprise sourcing the high carbon number fraction and blending and/or reacting same with fossil derived material in the fossil fuel production facility.

According to the foregoing aspect or embodiments, the fossil derived material is a liquid.

According to the foregoing aspect or embodiments, the method may comprise collecting and sequestering carbon dioxide produced during production of the hydrogen from the hydrogen production unit.

According to the foregoing aspect or embodiments, the low carbon number fraction from which the hydrogen is sourced may comprise one or more hydrocarbons having 2 or less carbon atoms.

According to the foregoing aspect or embodiments, the low carbon number fraction from which the hydrogen is sourced may be a light end fraction from a column separator that separates the high and low carbon number fractions based on differences in boiling points.

According to the foregoing aspect or embodiments, the low carbon number fraction from which the hydrogen is sourced may be a fraction that is non-condensable during the separation using the column separator and is recovered from a top portion of the column separator.

According to the foregoing aspect or embodiments, the column separator may be a distillation, stripping or scrubbing column.

According to the foregoing aspect or embodiments, the high carbon number fraction may comprise C5 to C22 carbon-containing molecules.

According to the foregoing aspect or embodiments, the high carbon number fraction may comprise C5 to C12 carbon-containing molecules for gasoline production.

According to the foregoing aspect or embodiments, the high carbon number fraction may comprise C7 to C16 carbon-containing molecules for jet fuel.

According to the foregoing aspect or embodiments, the high carbon number fraction may comprise C10 to C20 carbon-containing molecules for diesel.

According to another aspect, there is provided a method for producing a low carbon number fraction for use in a fuel production facility to produce a fuel that has renewable content, the method comprising: conducting a conversion process that uses a carbon-containing renewable feedstock as a feed to the process, the conversion process comprising a separation that fractionates the low carbon number fraction comprising carbon-containing molecules having 3 carbon atoms or less from a high carbon number fraction comprising carbon-containing molecules having 3 carbon atoms or more; providing the low carbon number fraction resulting from the separation to a hydrogen production unit to be fed, or co-fed with fossil material, to produce renewable hydrogen; and providing the renewable hydrogen to at least part of a fossil fuel production facility to supply hydrogen thereto and produce the fuel that has renewable content.

In one embodiment of the foregoing aspect, the hydrogen production unit may be located at the fossil fuel production facility or off-site.

According to the foregoing aspect or embodiments, the conversion process from which the hydrogen is sourced uses bio-methane, bio-oil, bio-ethanol or biomass as the carbon-containing renewable feedstock.

According to the foregoing aspect or embodiments, the high carbon number fraction may be provided to the fossil fuel production facility to blend and/or react same with fossil derived material in the fossil fuel production facility.

According to the foregoing aspect or embodiments, the fossil derived material is a liquid.

According to the foregoing aspect or embodiments, the method may further comprise causing collection and sequestration of carbon dioxide produced during production of the renewable hydrogen from the hydrogen production unit.

According to the foregoing aspect or embodiments, the low carbon number fraction may comprise one or more hydrocarbons having 3 or less carbon atoms.

According to the foregoing aspect or embodiments, the low carbon number fraction may be a light end fraction from a column separator that separates the high and low carbon number fractions based on differences in boiling points.

According to the foregoing aspect or embodiments, the low carbon number fraction may be a fraction that is non-condensable during the separation using the column separator and is recovered from a top portion of the column separator.

According to the foregoing aspect or embodiments, the column separator may be a distillation, stripping or scrubbing column.

According to the foregoing aspect or embodiments, the high carbon number fraction may comprise C5 to C22 carbon-containing molecules.

According to the foregoing aspect or embodiments, the high carbon number fraction may comprise C5 to C12 carbon-containing molecules for gasoline production.

According to the foregoing aspect or embodiments, the high carbon number fraction may comprise C7 to C16 carbon-containing molecules for jet fuel.

According to the foregoing aspect or embodiments, the high carbon number fraction may comprise C10 to C20 carbon-containing molecules for diesel.

In another aspect, there is provided a producing fuel having renewable content from biomass, the method comprising: converting at least part of a lignocellulosic feedstock to fuel in a first fuel production process that produces at least a low carbon number fraction and a high carbon number fraction, wherein the fuel produced from the first fuel production process comprises the high carbon number fraction; and converting at least another part of the lignocellulosic feedstock to fuel in a second fuel production process, the second fuel production process comprising using hydrogen for the hydroprocessing of a feed not derived from the lignocellulosic feedstock, wherein the hydrogen is produced by feeding the low carbon number fraction and fossil based natural gas to hydrogen production.

According to the foregoing aspect, the low carbon number fraction may comprise one or more hydrocarbons having 3 or less carbon atoms.

According to the foregoing aspect or embodiment, the low carbon number fraction may be a light end fraction from a column separator that separates the high and low carbon number fractions based on differences in boiling points.

According to the foregoing aspect or embodiments, the low carbon number fraction may be a fraction that is non-condensable during the separation using the column separator and is recovered from a top portion of the column separator.

According to the foregoing aspect or embodiments, the column separator may be a distillation, stripping or scrubbing column.

According to the foregoing aspect or embodiments, the high carbon number fraction may comprise C5 to C22 carbon-containing molecules.

According to the foregoing aspect or embodiments, the high carbon number fraction may comprise C5 to C12 carbon-containing molecules for gasoline production.

According to the foregoing aspect or embodiments, the high carbon number fraction may comprise C7 to C16 carbon-containing molecules for jet fuel.

According to the foregoing aspect or embodiments, the high carbon number fraction may comprise C10 to C20 carbon-containing molecules for diesel.

In another aspect, there is provided a method of producing fuel having renewable content from organic material, the method comprising: converting at least part of the organic material to fuel in a first fuel production process, the first fuel production process including a separation that produces at least a low carbon number fraction and a high carbon number fraction, wherein the fuel produced from the first fuel production process is an at least partially renewable liquid fuel comprising or derived from the high carbon number fraction, the high carbon number fraction comprising hydrocarbons having at least three carbons; and converting at least another part of the organic material to fuel in a second fuel production process, the second fuel production process comprising using hydrogen derived from the organic matter for the hydroprocessing of a feed not derived from the organic matter, wherein the hydrogen derived from the organic matter is produced in a process comprising feeding at least part of the low carbon number fraction and fossil based natural gas to hydrogen production, the low carbon number fraction comprising hydrocarbons having less than three carbons.

In another aspect, there is provided a method for producing fuel that has renewable content, the method comprising: a) providing carbon-containing renewable feedstock for a first fuel production process, the carbon-containing renewable feedstock comprising carbon-containing molecules having 3 carbon atoms or less, the first fuel production process comprising a separation that separates a low carbon number fraction from a high carbon number fraction, the first fuel production process producing a first fuel or fuel intermediate that comprises or is derived from the high carbon number fraction; b) providing hydrogen produced from a hydrogen production unit, wherein a feedstock for the hydrogen production comprises at least part of the low carbon number fraction; and c) producing a second fuel from a second fuel production process, the second fuel production process comprising hydroprocessing crude oil derived liquid hydrocarbon using hydrogen produced in step b), thereby hydrogenating the crude oil derived liquid hydrocarbon and producing a partially renewable fuel or fuel intermediate, wherein the first fuel or fuel intermediate is combined with at least one of (i) the crude oil derived liquid hydrocarbon prior to the hydroprocessing, (ii) the partially renewable fuel or fuel intermediate, or (iii) the second fuel, wherein second fuel comprises or is derived from the partially renewable fuel or fuel intermediate.

### BRIEF DESCRIPTION OF THE DRAWINGS

FIG. 1 shows a conversion process to produce renewable hydrogen from a thermal or thermochemical conversion process according to one embodiment.

FIG. 2 shows a conversion process to produce renewable hydrogen from a thermal or thermochemical conversion process according to another embodiment.

FIG. 3 shows a conversion process to produce renewable hydrogen from a thermal or thermochemical conversion process according to further embodiment.

FIG. 4 shows a conversion process to produce renewable hydrogen from a thermal or thermochemical conversion process according to yet another embodiment.

### DETAILED DESCRIPTION

The terminology used herein is for the purpose of describing certain embodiments only and is not intended to be limiting of the invention. For example, as used herein, the singular forms “a,” “an,” and “the” may include plural references unless the context clearly dictates otherwise. The terms “comprises”, “comprising”, “including”, and/or “includes”, as used herein, are intended to mean “including but not limited to.” The term “and/or”, as used herein, is intended to refer to either or both of the elements so conjoined. The phrase “at least one” in reference to a list of one or more elements, is intended to refer to at least one element selected from any one or more of the elements in the list of elements, but not necessarily including at least one of each and every element specifically listed within the list of elements. Thus, as a non-limiting example, the phrase “at least one of A and B” may refer to at least one A with no B present, at least one B with no A present, or at least one A and at least one B in combination. The terms “cause” or “causing”, as used herein, may include arranging or bringing about a specific result (e.g., a withdrawal of a gas), either directly or indirectly, or to play a role in a series of activities through commercial arrangements such as a written agreement, verbal agreement, or contract. The term “associated with”, as used herein with reference to two elements (e.g., a fuel credit associated with the transportation fuel), is intended to refer to the two elements being connected with each other, linked to each other, related in some way, dependent upon each other in some way, and/or in some relationship with each other. The term “plurality”, as used herein, refers to two or more. Unless defined otherwise, all technical and scientific terms used herein have the same meanings as commonly understood by one of ordinary skill in the art.

### Carbon-Containing Renewable Feedstock

The conversion process described herein from which hydrogen is sourced uses a “carbon-containing renewable feedstock”. The term includes a fuel, including a fuel intermediate, or other plant-derived material comprising carbon, that is not obtained from underground geologic formations and/or is capable of regeneration. Any suitable non-fossil, biologic source material obtained or derived directly or indirectly from plants or animals can be used as the organic material in various embodiments of the process to provide a carbon and/or energy source. This includes plant derived organic material comprising polysaccharides, including starch, cellulose and hemicellulose, oligosaccharides, disaccharides, monosaccharides, or a combination thereof. Other biologic, non-fossil source material that can be utilized as a carbon source includes compounds or molecules derived from non-sugar containing material, such as lignin and fats. The carbon-containing renewable feedstock may be in liquid form, solid form, gaseous form, or any combination thereof.

In one embodiment, the carbon-containing renewable feedstock is produced from (i) agricultural crops, (ii) trees grown for energy production, (iii) wood waste and wood residues, (iv) plants (including aquatic plants and grasses), (v) residues, (vi) fibers, (vii) animal wastes and other waste materials, and/or (viii) fats, oils, and greases (including recycled fats, oils, and greases). In one embodiment, the carbon-containing renewable feedstock is produced from (i) manure, (ii) agricultural by-products, (iii) energy crops, (iv) wastewater sludge, (v) industrial waste, (vi) source separated organics, and/or (vii) municipal solid waste.

According to one embodiment, the carbon-containing renewable feedstock includes material comprising starches, sugars or other carbohydrates derived from sugar or starch agricultural crops. The sugar or starch crops may include, but are not limited to, corn, wheat, barley, rye, sorghum, rice, potato, cassava, sugar beet, sugar cane, or a combination thereof.

Agricultural crops include biomass crops such as grasses, including C4 grasses, such as switch grass, energy cane, sorghum, cord grass, rye grass, miscanthus, reed canary grass, C3 grasses such as Arundo donax or a combination thereof.

Aquatic plants include algae may be used as the carbon-containing renewable feedstock. The algae may also be terrestrial in some embodiments. The algae may be used as a source of lipids for making biooil for example.

Residues include material remaining after obtaining sugar from plant biomass such as sugar cane bagasse, sugar cane tops and/or leaves, beet pulp, or residues remaining after removing sugar from Jerusalem artichoke or residues remaining after grain processing, such as corn fiber, corn stover or bran from grains. Agricultural residues include, but are not limited to soybean stover, corn stover, rice straw, sugar cane tops and/or leaves, rice hulls, barley straw, corn cobs, wheat straw, canola straw, oat straw, oat hulls, or corn cobs.

Forestry material includes any species of hardwood or softwood. The term includes residues, byproducts, waste or non-waste material from processing any hardwood or softwood species. Examples of waste include residues from sawmills, trimmings or slash from logging operations. Pulp and paper residue, includes non-pulp and non-paper products from chemical pulping or paper making such as black liquor, spent sulfite liquor, sludge, broke, fines or precipitated lignin.

Municipal waste includes post-consumer material or waste from a variety of sources, such as domestic, commercial, institutional and industrial sources. For example, the term includes refuse from waste collection, raw sewage and sewage sludge.

Biomass or biomass derived material can be a mixture of fibers that originate from different kinds of plant material, including mixtures of cellulosic and non-cellulosic biomass. In addition, the biomass may comprise fresh biomass, partially dried biomass, fully dried biomass, or a combination thereof. Moreover, new biomass varieties may be produced from any of those listed above by plant breeding or by genetic engineering.

As noted, the carbon-containing renewable feedstock also includes a fuel, which includes a fuel intermediate. A “fuel” includes liquid or gaseous material, which contains carbon, that can be combusted to produce power or heat and includes both transportation and heating fuel. The fuel may be a liquid at 20° C., such as an alcohol, or a gaseous fuel, such as methane, which are gases at this temperature. The fuel may exist in any form, including gaseous, liquid or compressed form. A “fuel intermediate” is a fuel that is a precursor used to produce a fuel product by a further conversion process, such as by a thermal or a chemical conversion, or a combination thereof.

Conversion Process from which the Renewable Hydrogen is Sourced

Renewable hydrogen is sourced from a conversion process that uses the carbon-containing renewable feedstock as a starting material and that employs a separation to produce at least a high carbon number fraction and a low carbon number fraction, as described further herein. The conversion process from which the hydrogen is sourced may be a thermal or thermochemical conversion process.

By the term “thermal or thermochemical conversion process”, it is meant a conversion in which heat is applied at one or more stages thereof at a temperature above 100 degrees Celsius and optionally in the presence of a catalyst and in which a high carbon number fraction and a low carbon number fraction are produced by a suitable separation. Such catalyst includes a chemical catalyst, such as a transition metal or a chemical catalyst, including in some embodiments, an acid or alkali.

The carbon-containing renewable feedstock used as a starting material can be in any form, including pretreated to facilitate downstream processing or fed to the conversion process in substantially raw form. Pretreatment includes mechanical size reduction, chemical and/or heat treatment, among other treatments known to those of ordinary skill in the art. Such treatment may be carried out on-site or at another location.

The high carbon number fraction may be produced during any stage of the conversion process. The conversion includes heat addition and optionally a catalyst in those embodiments employing a thermochemical conversion. For example, the catalyst may include components such as oxides, graphitic carbon and metals, such as transition metals. The catalyst includes a heterogeneous catalyst, including but not limited to a catalyst that acts in a different phase than its substrate. The catalyst may be present on a support material, such as alumina, zeolites or activated carbon. In another embodiment, the catalyst is a chemical catalyst, such as an acid or an alkali.

The conversion process may include a gasification, pyrolysis, Fischer-Tropsch synthesis, or a combination thereof. The pyrolysis or gasification may be conducted with or without a catalyst. A fuel or chemical product may be produced by gasification or pyrolysis. Some examples of fuels, including fuel intermediates, or chemical products produced from the gasification or pyrolysis of non-fossil organic material include syngas, hydrogen, methane, liquid hydrocarbons, pyrolysis oil and ammonia. Some examples of gasification and pyrolysis, and products generated from these processes, are described in more detail below.

In one embodiment, the high carbon number fraction of the conversion process is produced from fuel intermediates, such as syngas. As described above, syngas can originate from a variety of different processes, including gasification or pyrolysis. Examples of products made directly or indirectly from syngas include hydrocarbons, methane, hydrogen, methanol, ethanol and/or ammonia.

The conversion may include a process step that is a synthesis and thereby increases the molecular weight of an input to such process step relative to an output thereof. Such a process step includes a Fischer-Tropsch synthesis step within a thermochemical conversion that produces a fuel from a gaseous fuel such as syngas. For example, the production of hydrocarbons from syngas results in a fuel product (hydrocarbons) that has higher molecular weight components than the syngas fed to the step of Fischer Tropsch synthesis.

In one embodiment, the carbon-containing renewable feedstock fed to the thermal or thermochemical conversion process is a liquid fuel (at atmospheric pressure), such as ethanol. Such liquid fuel may be subjected to a step to produce higher molecular weight molecules, such as hydrocarbons, that make up the high carbon number fraction. Without being limiting, ethanol may be converted to hydrocarbons by a consolidated alcohol dehydration and oligomerization (CADO) conversion, which may be carried out, for example, at elevated temperature, such as from 250 to 550 degrees Celsius. The conversion uses any suitable metallic catalyst, such as a heterometallic zeolite catalyst. For example, the catalysis may be carried out as described in Narula et al., 2015, “Heterobimetallic Zeolite, InV-ZSM-5, Enables Efficient Conversion of Biomass Derived Ethanol to Renewable Hydrocarbons”, 5:16039; or Hannon et al., 2020, “Technoeconomic and life-cycle analysis of single-step catalytic conversion of wet ethanol into fungible fuel blendstocks”, 117(23): 12576-12583, which are each incorporated herein by reference and particularly for the purpose of describing such methodology. Alternatively, a catalytic conversion of ethanol into hydrocarbons may involve three steps, including (i) ethanol dehydration to ethylene, (ii) ethylene oligomerization to higher molecular weight hydrocarbons, and (iii) hydrogenation to saturate the oligomers to produce a high carbon number fraction.

In another embodiment, methane may be the carbon-containing renewable feedstock fed to the conversion process. Such conversion produces a high carbon number fraction comprising higher molecular weight products, including but not limited to ethane, ethanol, acetaldehyde, acetic acid or propane in a solid fuel cell-type electrolyte reactor.

The high carbon number fraction may be upgraded to produce one or more fuel products if desired. Such upgrading includes hydrocracking, hydrotreating and/or removal of impurities therefrom.

In one embodiment, the conversion process comprises a step of Fischer-Tropsch synthesis to produce hydrocarbons from syngas. In such embodiment, the carbon-containing renewable feedstock fed to the conversion process may be a plant-derived material comprising carbon, such as a renewable biomass feedstock, which is subjected to a gasification to produce syngas using known methods. The syngas is subsequently used to produce hydrocarbons having a range of sizes. The hydrocarbons are separated into a high carbon number fraction and a low carbon number fraction of C3 carbon-containing molecules or less after a suitable separation as described hereinafter. In one embodiment, a low carbon number fraction comprising methane is fractionated during such separation. The conversion process may also use syngas as the carbon-containing renewable feedstock fed to the process if gasification is conducted off-site relative to the location of the conversion process.

The production of liquid hydrocarbons from the carbon-containing renewable feedstock using Fischer-Tropsch synthesis may be advantageous in that such hydrocarbons can replace petroleum products such as naphtha, diesel or gasoline.

In one embodiment, the conversion process comprises a pyrolysis of a carbon-containing renewable feedstock, such as a plant-derived material comprising carbon, to produce biooil. Such conversion is a thermal or thermochemical conversion process comprising pyrolysis to produce the biooil. The conversion process to produce biooil may be considered a thermochemical conversion process if a catalyst is used during pyrolysis.

In the thermal conversion to produce biooil, the renewable biomass feedstock is fed to a pyrolyzer unit, in which thermal degradation occurs to produce biooil, char and a low carbon number fraction comprising methane and optionally other light gases. As would be appreciated by those of skill in the art, the renewable biomass feedstock may be dried or subjected to other optional processing steps, such as particle size reduction, prior to its introduction to the pyrolyzer unit.

The pyrolyzer unit typically is operated under elevated temperature conditions, such as in a range of about 200-800 degrees Celsius and in the absence of oxygen or under low oxygen conditions. The biooil, ultimately making up the high carbon number fraction, is condensed, while the non-condensable gases, which include CO, CO₂, H₂ and light hydrocarbon gases, such as CH₄, C₂H₆ and C₂H₄ are sent to an optional purification as the low carbon number fraction to remove unwanted gases.

### Separation to Produce the High and Low Carbon Number Fractions

The conversion process from which the hydrogen is sourced comprises a separation that results in a fractionation into the low carbon number fraction and the high carbon number fraction.

By the term “low carbon number fraction”, it is meant a carbon-containing fraction resulting from a separation where at least 50% of the carbon-containing molecules have 3 carbon atoms or less, where the separation is part of the conversion process. Examples of carbon-containing fractions include a hydrocarbon-containing fraction or mixture thereof, optionally with carbon-containing molecules having heteroatoms. The low carbon number fraction may comprise methane, among other gaseous components having 3 or less carbon atoms. If the low carbon number fraction is a mixture comprising hydrocarbons, the mixture may have carbon-containing molecules that have, on average, 3 carbon atoms or less.

In one embodiment, the low carbon number fraction of the conversion process is a fraction comprising carbon-containing molecules that have on average 3 carbon atoms or less (C3), 2 carbon atoms or less (C2) or 1 carbon atom (C1).

In one embodiment, the low carbon number fraction of the conversion process is a fraction comprising carbon-containing molecules that primarily comprises 1 carbon atom (C1) to 3 carbon atoms (C3), 1 carbon atom (C1) to 2 carbon atoms (C2), or that is a fraction primarily comprising carbon-containing molecules having 1 carbon atom (C1), such as methane, syngas, or a combination thereof.

In a preferred embodiment, the low carbon number fraction comprises methane. In another embodiment, the low carbon number fraction comprises carbon monoxide, among other components, such as hydrogen and carbon dioxide.

In such latter embodiment, carbon monoxide may be converted to methane using a step of methanation. Often such step involves the addition of hydrogen to ensure the optimal ratio of reactants for the methanation reaction. The methanation reaction is provided below:

CO+3H₂→CH₄+H₂O (3)

By the term “high carbon number fraction”, it is meant a carbon-containing fraction resulting from a separation where less than 50% of the carbon-containing molecules have 3 carbon atoms or less, where the separation is part of the conversion process. An example of a carbon-containing fraction is a hydrocarbon-containing fraction or mixture thereof, optionally with carbon-containing molecules having heteroatoms. The high carbon number fraction may be a fuel, including a fuel intermediate, or a chemical product. If the high carbon number fraction is a mixture of hydrocarbons, the mixture may have carbon-containing molecules that have, on average, 3 carbon atoms or more.

In one embodiment, the high carbon number fraction of the conversion process is a fraction having carbon-containing molecules that have on average 3 carbon atoms or more (C3), 4 carbon atoms or more (C4), 5 carbon atoms or more (C5), 6 carbon atoms or more (C6) or 7 carbon atoms or more (C7).

In one embodiment, the high carbon number fraction of the conversion process is a fraction having carbon-containing molecules that have on average 3 carbon atoms (C3) to 40 carbon atoms (C40), 4 carbon atoms (C4) to 30 carbon atoms (C30), 5 carbon atoms (C5) to 20 carbon atoms (C20), 6 carbon atoms (C6) to 20 carbon atoms (C20) or 7 carbon atoms (C7) to 18 carbon atoms (C18).

The high carbon number fraction is typically a fuel, including a fuel intermediate, but also includes a chemical product for other uses besides heating or transportation, such as fine chemicals. In one embodiment, the high carbon number fraction eventually becomes a fuel (e.g., transportation fuel). In one embodiment, the high carbon number fraction is a liquid at ambient temperature and pressures.

In one embodiment, the high carbon number fraction is naphtha, pyrolysis oil such as biooil, diesel, fuel oil, heating oil, kerosene, liquefied petroleum gas, asphalt base, gasoline, jet fuel, alkylate, heavy FCC gas, light FCC gas, reformate, isomerate and/or light straight run (LSR) fuel.

The separation to produce the high carbon number fraction and the low carbon number fraction may include a condensation, phase separation, fractional distillation and/or stripping. The separation need not occur in a single stage or in the same unit operation. That is, a high carbon number fraction can be separated from a stream in one stage and a low carbon number fraction can be separated from a different process stream in another stage of the conversion process. Further, the separation of a fraction can occur in a unit operation or process step that is not conventionally regarded as a separation per se, such as an upgrading step in which a low carbon number fraction is produced during such step and is separated from an upgraded product by virtue of its higher volatility and/or inability to condense under the operating conditions. An example includes a flue gas or a light gas produced during an upgrading step (e.g., hydrocracking or hydrotreating) of a hydrocarbon stream. Such flue gas or light gas is typically used as process heat within the conversion process or vented.

In those embodiments in which the separation is a condensation, such as during the production of biooil, non-condensable gases remaining after condensation or recovered during condensation make up the low carbon number fraction. Such non-condensable gases may comprise methane, ethane and/or butane, among other gaseous components.

Fractional distillation includes separation of the high carbon number fraction and low carbon number fraction based on molecules of different sizes having different boiling points. The fractional distillation may be carried out in a distillation tower. Typically, a bottom portion of a tower is fed with a feed of components to be separated, including the high and low carbon number fractions. Fractionation then occurs within the column by addition of heat thereto, typically steam. Vapour rises through the column and as the temperature decreases, components condense at different levels within the column. Non-condensable gases are typically removed from the top portion of the column. Non-condensable gases are usually sent to a boiler and used to generate heat and/or power for use within the process itself, but in the practice of embodiments herein, at least some of the non-condensable gases are recovered and provided to another process that includes hydrogen production (e.g., to produce an at least partially renewable product using renewable hydrogen). Typically, fractional distillation is used to separate components of hydrocarbons, such as those produced during a synthesis process, including without limitation, a Fischer-Tropsch or consolidated alcohol dehydration and oligomerization (CADO) process. However, fractional distillation may also be used to fractionate components of a crude biooil or other hydrocarbons.

Producing Hydrogen from the Low Carbon Number Fraction

The low carbon number fraction (e.g., comprising methane) resulting from a conversion process is fed, or co-fed with fossil material, to a hydrogen production unit to produce the renewable hydrogen. The hydrogen production unit may be located at the fossil fuel production facility or may be located off-site. For example, the hydrogen production unit may be located in proximity to a facility that carries out the above-described conversion process.

Optionally, the low carbon number fraction is purified to remove unwanted gases prior to being fed to hydrogen production unit. Such purification includes known methods such as pressure swing adsorption (PSA), scrubbing, or a combination of such steps. Further, as mentioned previously, if the low carbon number fraction is a flue gas comprising carbon monoxide, and optionally CO₂ and hydrogen, the low carbon number fraction (optionally with addition of hydrogen) may be subjected to a methanation step to produce methane for feeding to the hydrogen production unit.

In addition, the low carbon number fraction comprising methane, after purification, may be fed to a pipeline or transported to the fossil fuel production facility in a vessel.

In one embodiment, the method includes providing the methane from or derived from the low carbon number fraction, also referred to as “renewable methane” for use in producing one or more fuels from a fuel production process that includes hydrogen production, wherein providing the renewable methane includes withdrawing renewable natural gas (RNG) from a natural gas distribution system and/or allocating RNG withdrawn from a natural gas distribution system.

The term “renewable methane”, as used herein, refers to methane in the low carbon number fraction (raw or at least partially purified), methane in RNG, and/or methane that is recognized as and/or qualifies as renewable under applicable regulations. Establishing that a gas is recognized as and/or qualifies as renewable methane/RNG (e.g., originates from renewable sources) under applicable regulations can depend on whether the gas is transported by truck or by pipeline and the practices and requirements of the applicable regulatory agency, where such practices may include, for example, the use of chain of custody accounting methods such as identity preservation, book-and-claim, and a mass balance system.

In one embodiment, the renewable methane is provided in a feedstock for the renewable hydrogen production and/or the fossil fuel production process. In one embodiment, the feedstock contains raw methane, partially purified methane, or RNG. In one embodiment, the feedstock is natural gas withdrawn from a natural gas distribution system, a fraction of which is recognized as and/or qualifies as RNG under applicable regulations.

In one embodiment, a feedstock for the fuel production process is provided by withdrawing a gas from a natural gas distribution system, in which a fraction of the withdrawn gas is recognized as and/or qualifies as RNG under applicable regulations.

In general, at least a portion of the low carbon number fraction (e.g., the renewable methane) is provided for use in a fuel production process that includes hydrogen production (e.g., produces hydrogen from one or more hydrogen production units). The term “hydrogen production unit” or “hydrogen production unit”, as used herein, refers to a system or combination of systems primarily used for production of hydrogen from methane containing gas (e.g., natural gas).

In general, at least a portion of the renewable hydrogen is produced from a hydrogen production unit that includes a methane reformer and a hydrogen purification system. The methane reformer and/or hydrogen purification system can be based on any suitable technology. In one embodiment, the methane reformer includes one or more reactors configured to promote a steam methane reforming (SMR), autothermal reforming (ATR), partial oxidation (POX), and/or dry methane reforming (DMR) reaction.

In one embodiment, the methane reformer includes a steam methane reformer. A steam methane reformer includes one or more reactors configured to support the SMR reaction of Eq. (1) and may provide for the WGS reaction of Eq. (2). For example, a steam methane reformer typically includes one or more reforming tubes filled with catalyst, which are surrounded by a combustion chamber. The heat required for the catalytic reforming of Eq. (1) is typically provided by feeding a fuel to one or more burners that fire into the combustion chamber such that combustion of the fuel outside the tubes heats the gas passing through the tubes. Without being limiting, the catalyst may be nickel-based. Optionally, the catalyst is supported on a support of suitable material (e.g., alumina, etc.). Optionally, promoters (e.g., MgO) are added. Without being limiting, conventional steam methane reformers may operate at pressures between 200 and 600 psig and temperatures between about 450 to 1000° C.

In one embodiment, the hydrogen production unit includes one or more water gas shift (WGS) reactors (i.e., in addition to the methane reformer and the hydrogen purification system). For example, in the SMR reaction discussed with regard to Eq. 1, the SMR catalyst may be active with respect to the WGS reaction in Eq. 2. For example, the gas leaving the steam reformer may be in equilibrium with respect to the WGS reaction. However, syngas leaving the steam methane reformer typically contains a significant amount of carbon monoxide that can be converted to hydrogen (i.e., in a WGS reaction). Since the WGS reaction is exothermic, cooling of the syngas over a selected catalyst may promote the WGS reaction, and thus may increase the H₂ content of the syngas while decreasing the CO content. Accordingly, it may be advantageous to provide one or more WGS reactors (i.e., shift reactors) downstream of the methane reforming. In general, shift reactors may use any suitable type of shift technology (e.g., high temperature shift conversion, medium temperature shift conversion, low temperature shift conversion, sour gas shift conversion, or isothermal shift). For example, WGS reactions may be conducted at temperatures between 320-450° C. (high temperature) and/or between 200-250° C. (low temperature). Without being limiting, high temperature thermal shift may be conducted with an iron oxide catalyst (e.g., supported by chromium oxide), whereas low temperature thermal shift may be conducted with a Cu/ZnO mixed catalyst. Optionally, a promoter is added. In general, there may be one or more stages of WGS to enhance the hydrogen concentration in the syngas. For example, the WGS may be conducted in a high temperature WGS reactor (e.g., 350° C.) followed by a low temperature WGS reactor (e.g., 200° C.). Without being limiting, the syngas from the SMR and/or WGS reactor (e.g., which may be at about 210-220° C.) can be cooled (e.g., to 35-40° C.), and the condensate separated, prior to hydrogen purification.

The hydrogen purification system is based on any suitable hydrogen purification process or combination of processes that treats the syngas from the methane reforming and/or WGS to separate a portion of the hydrogen from a portion of the carbon dioxide, carbon monoxide, methane and/or any other impurities in the syngas, and to provide a stream enriched in hydrogen (i.e., containing at least 80% hydrogen). For example, in one embodiment, the hydrogen purification system is configured to remove carbon dioxide and/or unreacted methane from the syngas. Without being limiting, some examples of suitable hydrogen purification processes for the hydrogen purification include: (a) absorption, (b) adsorption, (c) membrane separation, (d) cryogenic separation, and/or (e) methanation.

Absorption processes that remove carbon dioxide may include scrubbing with a weak base (e.g., hot potassium carbonate) or an amine (e.g., ethanolamine). For example, carbon dioxide may be captured using a monoethanolamine (MEA) system or a methyl-diethanolamine (MDEA) system. An MEA system may include one or more absorption columns containing an aqueous solution of MEA at about 30 wt %. The outlet liquid stream of solvent may be treated to regenerate the MEA and separate carbon dioxide.

Adsorption processes may use an adsorbent bed (e.g., molecular sieves, activated carbon, active alumina, or silica gel) to remove impurities such as methane, carbon dioxide, carbon monoxide, nitrogen, and/or water from the syngas. More specifically, these impurities may be preferentially adsorbed over hydrogen, yielding a relatively pure hydrogen stream. Moreover, since the impurities may be adsorbed at higher partial pressures and desorbed at lower partial pressures, the adsorption beds may be regenerated using pressure. Such systems/processes are typically referred to as pressure swing adsorption (PSA) systems/processes. In general, PSA systems may be the most common hydrogen purification processes used in hydrogen production units. Some adsorption beds may be regenerated with temperature.

Membrane separation is based on different molecules having varying permeability through a membrane. More specifically, some molecules, referred to as the permeant(s) or permeate, diffuse across the membrane (e.g., to the permeate side). Other molecules do not pass through the membrane and stay on the retentate side. The driving force behind this process is a difference in partial pressure, wherein the diffusing molecules move from an area of high concentration to an area of low concentration. For hydrogen purification, the permeable gas typically is hydrogen. While hydrogen separation through a membrane may have a relatively high recovery rate, this may come at the expense of reduced purity.

Cryogenic separation is based on the phenomena that different gases may have distinct boiling/sublimation points. Cryogenic separation processes may involve cooling the product gas down to temperatures where the impurities condense or sublimate and can be separated as a liquid or a solid fraction, while the hydrogen accumulates in the gas phase. For example, cryogenic separations may use temperatures below −10° C. or below −50° C.

Methanation is a catalytic process conducted to convert the residual carbon monoxide and/or carbon dioxide in the syngas to methane, according to the following.

CO+3H₂→CH₄+H₂O (Eq. 3)

Since the methanation reaction consumes hydrogen, it can be advantageous to provide a carbon dioxide removal step prior to the methanation step.

As noted, carbon dioxide may be produced during hydrogen production in the hydrogen production unit. In one embodiment, the carbon dioxide from the hydrogen production unit is introduced underground to further reduce GHG emissions associated with one or more fuels produced by the process. Such biogenic carbon dioxide can be introduced to an apparatus for transporting the biogenic carbon dioxide to one or more sites that inject carbon dioxide underground or under a sea bed. The apparatus may include a carbon dioxide pipeline, a vessel or other transportation means as discussed further below.

Examples of methods whereby CO₂ could become introduced and, most advantageously retained underground, include residual trapping, when CO₂ becomes trapped in the gaps between rocks; solubility trapping, which occurs when CO₂ dissolves in water; and mineral trapping, which involves the conversion of CO₂ into solid mineral. Any one or a combination of these methods may be used in accordance with certain embodiments.

### Fuel Production

In general, the renewable hydrogen is used for producing one or more fuels (e.g., partially renewable fuel). For example, in one embodiment the renewable hydrogen is used in a fuel production process, also referred to herein as a fossil fuel production process, to produce one or more transportations fuels, which includes a transportation fuel intermediate. In general, the fuel production process can be any fuel production process that includes methane reforming of natural gas to produce syngas. In one embodiment, the fuel production process produces syngas that is purified to provide hydrogen used in the production of a transportation fuel. For example, in one embodiment, the hydrogen is used in a gas fermentation or a Fischer-Tropsch synthesis. In one embodiment, the hydrogen is used to hydrogenate crude oil derived liquid hydrocarbon. In one embodiment, the hydrogen is used to hydrogenate renewable oils and/or fats.

In a preferred embodiment, the fuel production process includes one or more hydroprocessing steps wherein crude oil derived liquid hydrocarbon is hydrogenated. The term “crude oil derived liquid hydrocarbon”, as used herein, refers to any carbon-containing material obtained and/or derived from crude oil that is liquid at standard ambient temperature and pressure. The term “crude oil”, as used herein, refers to petroleum extracted from geologic formations (e.g., in its unrefined form). Crude oil includes liquid, gaseous, and/or solid carbon-containing material from geologic formations, including oil reservoirs, such as hydrocarbons found within rock formations, oil sands, or oil shale. Advantageously, since a feedstock for the hydrogen production process and/or the fuel production process can contain renewable methane, one or more fuels produced from the process can have renewable content. In one embodiment, the fuel production process produces one or more liquid transportation fuels having renewable content.

In one embodiment, the fuel production process includes one or more hydroprocessing steps in which a crude oil derived liquid hydrocarbon obtained from or at an oil refinery is hydrogenated. Oil refineries (i.e., petroleum refineries) include a variety of unit operations and processes. One of the upstream unit operations is the continuous distillation of crude oil. For example, crude oil may be desalted and piped through a hot furnace before being fed into a distillation unit (e.g., an atmospheric distillation unit or vacuum distillation unit). Inside the distillation unit, the liquids and vapours separate into fractions based on their respective boiling points. The lighter fractions, including naphtha, rise to the top, the middle fractions, including kerosene and diesel/heating oil, remain in the middle, and the heavier liquids, often called gas oil, settle at the bottom. After distillation, each of the fractions may be further processed (e.g., in a cracking unit, a reforming unit, alkylation unit, light ends unit, dewaxing unit, coking unit, etc.).

Cracking units use heat, pressure, catalysts, and sometimes hydrogen, to crack heavy hydrocarbon molecules into lighter ones. Complex refineries may have multiple types of crackers, including fluid catalytic cracking (FCC) units and/or hydrocracking units. FCC units (i.e., catalytic crackers or “cat crackers”) are often used to process gas oil from distillation units. The FCC process primarily produces gasoline, but may also produce by-products such as liquefied petroleum gas (LPG), light olefins, light cycle oil (LCO), heavy cycle oil (HCO), and clarified slurry oil. Hydrocracking units (i.e., hydrocrackers), which consume hydrogen, may be also used to process gas oils from a distillation unit. However, since the hydrocracking process combines hydrogenation and catalytic cracking, it may be able to handle feedstocks that are heavier than those that can be processed by FCC, and thus may be used to process oil from cat crackers or coking units. Hydrocrackers typically produce more middle distillates (e.g., kerosene and/or diesel) than gasoline. Hydrocrackers may also hydrogenate unsaturated hydrocarbons and any sulfur, nitrogen or oxygen compounds (e.g., reduces sulfur and nitrogen levels).

Reforming units (i.e., catalytic reforming units) use heat, moderate pressure, and catalysts to convert heavy naphtha, which typically has a low octane rating, and/or other low octane gasoline fractions, into high-octane gasoline components called reformates. Alkylation units may convert lighter fractions (e.g., by-products of cracking) into gasoline components. Isomerization units may convert linear molecules to higher-octane branded molecules for blending into gasoline or as feedstock to alkylation units.

Hydrotreating units may perform a number of diverse processes including, for example, the conversion of benzene to cyclohexane, aromatics to naphtha, and the reduction of sulfur, oxygen, and/or nitrogen levels. For example, hydrotreating units are often used to remove sulfur from naphtha streams because sulfur, even in very low concentrations, may poison the catalysts in catalytic reforming units. In oil refineries, hydrotreaters are often referred to as hydrodesulfurization (HDS) units. Hydrotreating units may be used for kerosene, diesel, and/or gas oil fractions. For example, hydrotreating units for diesel may saturate olefins, thereby improving the cetane number.

Both hydrotreating and hydrocracking fall within the scope of the term hydroprocessing and consume hydrogen. In general, hydrotreating is less severe than hydrocracking (e.g., there is minimal cracking associated with hydrotreating). For example, the time that the feedstock remains at the reaction temperature and the extent of decomposition of non-heteroatoms may differ between hydrotreating and hydrocracking. Hydroprocessing is typically conducted in a hydroprocessing unit. The term “hydroprocessing unit”, as used herein, refers to one or more systems (e.g., hydrogenation reactor(s), pumps, compressor(s), separation equipment, etc.) provided for hydroprocessing operations. For example, hydrotreating units and hydrocracking units are examples of hydroprocessing units.

In one embodiment, the fossil fuel production process includes providing at least renewable methane from the low carbon number fraction or RNG associated with the renewable methane to feed a hydrogen production unit (e.g., to produce renewable hydrogen). The renewable methane may also be co-fed with fossil material. The renewable hydrogen so produced (e.g., renewable hydrogen) is then provided to a feed used to hydrogenate crude-oil derived liquid hydrocarbon, which ultimately is part of one or more fuels produced by the fossil fuel production facility.

In one embodiment, some of the renewable hydrogen is incorporated into the crude oil derived liquid hydrocarbon. The incorporation of renewable hydrogen into crude oil derived liquid hydrocarbon encompasses the addition, incorporation, and/or bonding of renewable hydrogen to the crude oil derived liquid hydrocarbon. Such reactions include hydrogenation, which includes, without limitation, any reaction in which renewable hydrogen is added to a crude oil derived liquid hydrocarbon through a chemical bond or linkage to a carbon atom. The renewable hydrogen may be bonded to a carbon backbone, a side chain, or a combination thereof, of a linear or ring compound of a crude oil derived liquid hydrocarbon. The addition and/or incorporation of renewable hydrogen into the crude oil derived liquid hydrocarbon may include the addition of renewable hydrogen to an unsaturated or a saturated hydrocarbon. This includes addition of renewable hydrogen to unsaturated groups, such as alkenes or aromatic groups, on the crude oil derived liquid hydrocarbon (i.e., the saturation of aromatics, olefins (alkenes), or a combination thereof). The addition and/or incorporation of hydrogen may be accompanied by the cleavage of a hydrocarbon molecule. This may include a reaction that involves the addition of a hydrogen atom to each of the molecular fragments that result from the cleavage. Without being limiting, such reactions may include ring opening reactions and/or dealkylation reactions. Such reactions are known to those of skill in the art. The hydrogenation reactions may be conducted in a “hydrogenation reactor”. As used herein, the term “hydrogenation reactor” includes any reactor in which hydrogen is added to a crude oil derived liquid hydrocarbon. Hydrogenation reactions may be carried out in the presence of a catalyst.

In one embodiment, the renewable hydrogen is added to the crude oil derived liquid hydrocarbon in a hydrotreating process. In one embodiment, the renewable hydrogen is added to the crude oil derived liquid hydrocarbon in a hydrocracking process. In contrast to hydrotreating, which may provide a conversion level less than about 20 wt % (and more typically less than 15 wt %), a hydrocracker may provide a conversion level that is between 20 and 100 wt %. By the term “conversion level”, it is meant the difference in amount of unconverted crude oil derived liquid hydrocarbon between feed and product divided by the amount of unconverted crude oil derived liquid hydrocarbon in the feed. Unconverted crude oil derived liquid hydrocarbon is material that boils above a specified temperature. Without being limiting, for vacuum gas oil, a typical specified temperature may be 343° C. The conditions used in hydrocrackers are conventional and can be readily selected by those of ordinary skill in the art.

In one embodiment, the renewable hydrogen is added to the crude oil derived liquid hydrocarbon in hydroprocessing process that includes hydrogenation, hydrocracking, and/or hydrodesulfurization. In one embodiment, the renewable hydrogen is directed and/or allocated within the fuel production facility (e.g., an oil refinery) such that it preferentially ends up in one or more predetermined fuel products and/or is preferentially consumed in one or more predetermined unit operations.

In one embodiment, the renewable hydrogen is directed and/or allocated within the fuel production facility such that it preferentially ends up in gasoline or a gasoline blending component. The term “gasoline” refers generally to a liquid fuel or liquid fuel component suitable for use in spark ignition engines (e.g., which may be predominantly C₅-C₉ hydrocarbons, and which may boil in the range between 32° C. and 204° C.). For example, the term gasoline can refer to gasoline blending components. In one embodiment, the renewable hydrogen is directed and/or allocated within the fuel production facility such that it ends up in a product that satisfies applicable gasoline specifications (e.g., ASTM D4814).

In one embodiment, the renewable hydrogen is directed and/or allocated within the fuel production facility (e.g., at an oil refinery) such that it preferentially ends up in diesel or a diesel blending component. The term “diesel” refers generally to a liquid fuel or liquid fuel component suitable for use in compression ignition engines (e.g., which may be predominantly C₉-C₂₅ hydrocarbons, and which may boil in the range between 187° C. and 417° C.). For example, the term diesel can refer to diesel blending components. In one embodiment, the renewable hydrogen is directed and/or allocated within the fuel production facility such that it ends up in a product that satisfies applicable diesel specifications (e.g., ASTM D975).

In one embodiment, the renewable hydrogen is directed and/or allocated to one or more hydrotreaters at the fuel production facility. An oil refinery typically has multiple hydrotreaters. For example, an oil refinery may include a naphtha hydrotreater (e.g., treats heavy naphtha prior to reforming), a kerosene hydrotreater (e.g., removes sulfur and improves smoke point of kerosene), a diesel hydrotreater (e.g., removes sulfur and nitrogen and increases the cetane number of diesel), a vacuum gas oil (VGO) hydrotreater, and/or a resid hydrotreater (e.g., to treat atmospheric residue or vacuum residue). An oil refinery may also include a distillate hydrotreater, which improves the quality of distillate boiling range feedstocks (e.g., uses a feed that includes crude oil derived liquid hydrocarbon in the kerosene and diesel boiling point range). In general, a distillate hydrotreater can treat an individual distillate fraction or a mixture of various distillate fractions, as well as other refinery streams, to meet specifications required for the finished fuel (e.g., sulfur and/or cetane number specifications).

In one embodiment, the renewable hydrogen is directed and/or allocated to one or more hydrocrackers at the fuel production facility. In an oil refinery, hydrocrackers may be used to process gas oil, aromatic cycle oils, and/or coker distillates. These feeds may originate from atmospheric and/or vacuum distillation units, delayed cokers, fluid cokers, visbreakers, or fluid catalytic cracking units. Middle distillates from a hydrocracker usually meet or exceed finished product specifications, but the heavy naphtha from a hydrocracker may be sent to a catalytic reformer for octane improvement. In general, hydrocrackers may be the largest hydrogen consumer in an oil refinery. Using the renewable hydrogen in a hydrocracking process exploits this high demand, and may be advantageous in that more renewable hydrogen may be physically incorporated into the fuel (relative to using the renewable hydrogen in a hydrotreating process for desulfurization where a portion of the renewable hydrogen may be converted to hydrogen sulfide). In one embodiment, the renewable hydrogen is selectively directed and/or allocated to a hydrocracker that produces more diesel than gasoline (i.e., on a volume basis).

Advantageously, since the low carbon number fraction and/or renewable hydrogen can be feedstock for the fossil fuel production process, the fossil fuel production process can produce partially renewable fuel. By the term “partially renewable fuel”, it is meant fuel produced by co-processing a feedstock derived from renewable biomass and non-renewable feedstocks.

In general, the fuel production process can produce one or more partially renewable fuels. For example, each partially renewable fuel can be a blending component that can be used as a fuel or blended to provide a fuel. The term “fuel”, as used herein, can refer to finished fuels, blending components, and/or fuel compositions. In general, the partially renewable fuel can be any suitable fuel including fuel selected from gasoline, diesel, jet fuel, and/or fuel oil. In one embodiment, the partially renewable fuel produced is jet fuel. In one embodiment, the partially renewable fuel produced is diesel. In one embodiment, the partially renewable fuel produced is fuel oil (e.g., a transportation fuel, such as bunker fuel, or heating oil).

Advantageously, a partially renewable fuel can have renewable content. In general, the renewable content of a partially renewable fuel can be dependent the applicable regulations and/or the authority providing incentives (e.g., fuel credits). For example, while the renewable content of a partially renewable fuel is generally dependent on the quantity of renewable feedstock used to provide a given quantity of the fuel produced, in some cases the fuel production process can produce multiple fuels. Depending on the regulations, the renewable energy of the feedstock may be allocated to one or more specific fuels, to all of the products equally, to all qualifying fuels (i.e., fuels that qualify for incentives under applicable regulations), and/or may be dependent on tracking the renewable feedstock (e.g., based on an energy or mass balance) through the process. In general, the renewable content of the fuel(s) produced, and thus the number and/or value of fuel credits generated, can be dependent on the boundary of the fuel production process.

### Quantifying the Renewable Content

In one embodiment, the renewable content of one or more fuels produced from the fuel production process (e.g., partially renewable fuel) is quantified. In general, quantifying the renewable content in the fuel includes determining how much renewable content (e.g., by volume, mass, or energy) is in an amount of the fuel produced (e.g., a batch, which may be expressed as volume, mass, or energy).

Whether a portion or all of a fuel qualifies as renewable, the method used to quantify the renewable content of the fuel, and/or the carbon intensity of the fuel, can be dependent on applicable regulations (e.g., low carbon fuel regulations and/or renewable energy regulations for the transport sector). For example, various governments have provided legislative measures to promote biofuels and/or reduce GHG emissions from the transport sector. The Government of Canada is developing a Clean Fuel Standard to reduce the lifecycle carbon intensity of fuels and energy used in Canada. The United States has adopted the Renewable Fuel Standard (RFS), a federal program that mandates transportation fuel sold in the U.S. contain a minimum volume of renewable fuels. California's Air Resource Board (CARB), which is a state agency, provides regulations for the Low Carbon Fuel Standard (LCFS). The United Kingdom is implementing its Renewable Transport Fuel Obligation (RTFO). The European Union has implemented the Renewable Energy Directive (RED), which mandates that a certain percent of all energy in road transport fuels be produced by renewable sources, and the Fuel Quality Directive (FQD), which requires the road transport fuel mix be less carbon intensive than fossil baseline. In many instances, compliance with targets and/or mandates can be demonstrated with fuel credits (e.g., tradable certificates such as RFS's Renewable Identification Numbers (RINs), LCSF fuel credits, or UK's Renewable Transport Fuel Certificates (RTFCs)).

Various approaches for quantifying the renewable content, which may be necessary for demonstrating compliance with some regulations (e.g., for quantify renewable fuel volumes) and/or generating fuel credits, have been proposed. For example, some of these methodologies are based on analyzing the products of the fuel production process (e.g., a carbon 14 analysis), while others are based on how much renewably sourced feedstock is used. In respect of the latter, some proposed approaches include (a) the mass balance approach, and (b) the energy content approach (e.g., which may include measuring input and output mass or energy contents, respectively).

In accordance with one embodiment of the disclosure, the renewable content of one or more fuels produced from the fuel production process is quantified by determining how much renewable content (e.g., by volume, mass, or energy) originating from the low carbon number fraction, renewable methane, RNG, and/or renewable hydrogen is in an amount of the fuel produced (e.g., a batch, which may be expressed as volume, mass, or energy). In one embodiment, the renewable content is measured as a mass % (i.e., mass of renewable hydrogen in a batch per total mass of the batch, expressed as a percentage). In one embodiment the renewable content is measured as kg of renewable hydrogen/barrel of fuel. In one embodiment, the renewable content is measured as a volume % (i.e., volume of renewable hydrogen in a batch per total volume of the batch, expressed as a percentage). In one embodiment the renewable content is measured as L of renewable hydrogen/barrel of fuel. In one embodiment, the renewable content is measured as an energy percentage (i.e., energy of renewable hydrogen in a batch per total energy of the batch). In one embodiment, the renewable content is quantified using one of the approaches described in WO 2021/035352, which is hereby incorporated by reference and particularly for the purpose of describing such methodology.

In one embodiment, the renewable content of one or more fuels produced from the fuel production process is determined using a mass balance or energy content approach. Mass balance and energy content approaches to determining renewable content, which can include calculation methods based on chemical reactions in the refining unit, typically require measurements to be taken prior to the start of the process and thereafter (i.e., monitoring of input and output mass or energy content).

In one embodiment, the renewable content of the fuel(s) produced is quantified using energy. For example, in one embodiment, the yield of renewable content (in energy units) for the production of a given fuel is given as

Yield of renewable content(in energy units)=renewable fraction of feedstock*energy of fuel produced (4)

wherein the renewable fraction of feedstock is calculated using energy. In general, the yield of renewable content for a particular fuel can be dependent on the process boundaries used (e.g., the feedstock(s) used and the products produced) and/or how the energy of the renewable hydrogen is allocated.

In one embodiment, the renewable content is quantified using the renewability, as proposed in the “RTFO Guidance Part One Process Guidance”, version January 2020, used for reporting under the Renewable Transport Fuel Obligations Order 2007 No. 3072, which is hereby incorporated by reference and particularly for the purpose of describing such methodology. In this case, the renewability of a fuel refers to the percentage of a fuel (by energy) that is recognized as and/or qualifies as renewable and can be calculated using Eq. (5).

MJ of renewable fuel=Total MJ of renewable feedstocks/Total MJ of all feedstocks*Total MJ of fuel produced (5)

In general, using renewability to quantify the renewable content of one or more fuels produced from a feedstock containing renewable methane and a feedstock containing crude-oil derived liquid hydrocarbon may be particularly suitable as part of the energy of the fuel is from renewable sources (e.g., biogas) and part is from non-renewable sources.

In one embodiment, the method includes generating or causing the generation of a fuel credit. In one embodiment, the fuel credit is generated in dependence on the low carbon number fraction, renewable methane, and/or renewable hydrogen being used to produce the fuel. In one embodiment, a fuel credit is generated in dependence on the renewable hydrogen being incorporated into the fuel. In one embodiment, a fuel credit is generated in dependence on a calculated renewable content of the fuel product. In one embodiment, the fuel credit is generated in dependence on a magnitude of carbon intensity of the renewable content (i.e., of the renewable hydrogen). In one embodiment, the process includes generating, or causing the generation of, a fuel credit for the renewable portion of the fuel (i.e., the renewable content).

### Use of the High Carbon Number Fraction in a Fuel Production Facility

Optionally, the present disclosure further includes providing or sourcing the high carbon number fraction and blending and/or reacting such high carbon number fraction with fossil derived material in the fossil fuel production facility.

The term “fossil derived material” as used herein includes a fuel, fuel intermediate, components for blending, heating oil or feedstock from a fossil source.

For example, fuels produced by product blending processes include gasoline, jet fuels, heating oils and diesel. Product blending may include blending different fossil derived materials in the form of component streams into various grades of fuel. For example, for gasoline, a fossil fuel production facility, such as an oil refinery, may blend different fossil derived material (e.g., component streams) into various grades of gasoline. The grades are often based on octane number. For example, 83 octane may be blended with an oxygenated fuel such as ethanol, (which may itself be derived from a carbon-containing renewable feedstock). Specifications for fuels may be set based on a Ried Vapour Pressure as well, which is a measure of volatility of a fuel blend. Specifications may vary depending on the climate where the fuel is intended for use.

In one embodiment, various components may be blended to produce a fuel product. Such components from a fuel production facility include alkylate, heavy FCC gas, light FCC gas, reformate, isomerate, LSR and butane. Some or all of the high carbon number fraction may be added to any one of these fossil derived materials, including a final fuel product, to increase the renewable content of the fuel.

For example, in those embodiments in which the high carbon number fraction is alkylate, heavy FCC gas, light FCC gas, reformate, isomerate and/or light straight run (LSR) fuel, such high carbon number fraction may be blended as part of a blending process carried out in the fuel production facility or a separate blending facility with one or more other fossil derived materials or components to produce a fuel meeting a certain product specification(s) and having renewable content. The blended fuel may meet any specifications as required, including but not limited to volatility, octane level and/or viscosity.

The high carbon number fraction in one embodiment is a fuel product, including but not limited to gasoline, jet fuel, heating oil and diesel and may be blended with a fuel product from the fuel production facility.

In another embodiment, the high carbon number fraction, optionally after upgrading and/or purification, may be introduced to a distribution system, such as a pipeline or another transportation system, which includes trucking, and delivered to an end user and/or to the fuel production facility. Such distribution system may be fungible and therefore the molecules of the high carbon number fraction need not necessarily correspond to those introduced to the system and still be considered renewable by regulators. Similar consideration may apply as described in relation to distributing renewable methane by distribution systems as discussed above.

In another embodiment, the high carbon number fraction is reacted in any one of a variety of stages to produce a fuel in the refinery. In one embodiment, the high carbon number, after optional upgrading and/or purification, may be reacted with fossil derived material in the fossil fuel production facility. Without being limiting, such embodiment may be advantageous in that it uses existing infrastructure and/or unit operations in a refinery and thus may benefit from economies of scale.

For example, the high carbon number, after optional upgrading and/or purification, may be fed or co-fed with fossil derived material to any hydroprocessing unit in the fuel production facility and reacted (e.g., upgraded) therein.

In one embodiment, the high carbon number, after optional upgrading and/or purification, may be fed or co-fed with fossil derived material to one or more hydrotreaters at the fuel production facility. For example, the high carbon number fraction may be fed or co-fed to a naphtha hydrotreater (e.g., treats heavy naphtha prior to reforming), a kerosene hydrotreater (e.g., removes sulfur and improves smoke point of kerosene), a diesel hydrotreater (e.g., removes sulfur and nitrogen and increases the cetane number of diesel), a vacuum gas oil (VGO) hydrotreater, and/or a resid hydrotreater (e.g., to treat atmospheric residue or vacuum residue) and/or a distillate hydrotreater, which improves the quality of distillate boiling range feedstocks (e.g., uses a feed that includes crude oil derived liquid hydrocarbon in the kerosene and diesel boiling point range).

In one embodiment, the high carbon number fraction may be fed or co-fed with fossil derived material to one or more hydrocrackers at the fuel production facility. Such hydrocrackers may be used to process gas oil, aromatic cycle oils, and/or coker distillates. The high carbon number fraction may be fed or co-fed with fossil derived material from atmospheric and/or vacuum distillation units, delayed cokers, fluid cokers, visbreakers, or fluid catalytic cracking units. Middle distillates from a hydrocracker usually meet or exceed finished product specifications, but the heavy naphtha from a hydrocracker may be sent to a catalytic reformer for octane improvement. In general, hydrocrackers may be the largest hydrogen consumer in an oil refinery. As noted, using the renewable hydrogen in a hydrocracking process exploits this high demand, and may be advantageous in that more renewable hydrogen may be physically incorporated into the fuel. Feeding or co-feeding the high carbon number fraction, as appropriate (e.g., the feeds are compatible), to a hydrocracker may further increase the yield of renewable content of the fuel.

### DESCRIPTION OF SPECIFIC EMBODIMENTS DEPICTED IN THE DRAWINGS

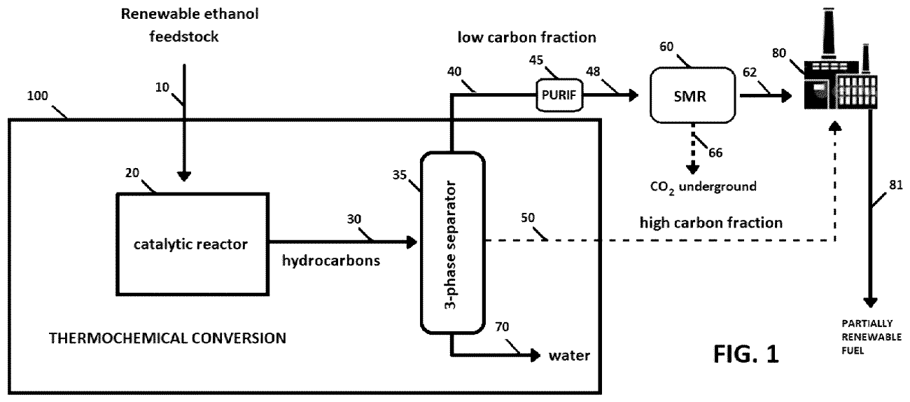

Turning now to the drawings, FIG. 1 shows a thermochemical conversion process 100 in which a renewable ethanol feedstock 10 is converted to liquid hydrocarbons in a catalytic reactor 20. The renewable ethanol feedstock 10 may originate from a grain, corn, or biomass, in which sugars are liberated from the feedstock and converted to ethanol using biocatalysts.

In the thermochemical conversion process 100, the renewable ethanol feedstock 10 is fed to a catalytic reactor 20 that is operated under conditions effective to convert the renewable ethanol feedstock 10 to hydrocarbons 30. The renewable ethanol feedstock 10 fed to the catalytic reactor 20 may be a wet ethanol vapour (containing water) or dried previously using conventional technology to remove water such as distillation and molecular sieves.

The catalytic reactor 20 converts the ethanol feedstock 10 into higher molecular weight hydrocarbons 30 and water. The catalysis may occur in a single processing step as depicted in FIG. 1 using a metal-exchanged zeolite catalyst or may be a multi-step conversion of ethanol to hydrocarbon stream 30. The depicted catalysis in the catalytic reactor 20 is a consolidated alcohol dehydration and oligomerization (CADO) conversion and may be carried out, for example, at elevated temperature, such as from 250 to 550 degrees Celsius. The catalysis uses any suitable metallic catalyst, such as a heterometallic zeolite catalyst. For example, the catalysis may be carried out as described in Narula et al., 2015, “Heterobimetallic Zeolite, InV-ZSM-5, enables Efficient Conversion of Biomass Derived Ethanol to Renewable Hydrocarbons”, 5:16039; or Hannon et al., 2020, “Technoeconomic and life-cycle analysis of single-step catalytic conversion of wet ethanol into fungible fuel blendstocks”, 117(23): 12576-12583, which are each incorporated herein by reference and particularly for the purpose of describing such methodology. Alternatively, a catalytic conversion of ethanol into hydrocarbons may involve three steps prior to the separation, including (i) ethanol dehydration to ethylene, (ii) ethylene oligomerization to higher molecular weight hydrocarbons, and (iii) hydrogenation to saturate the oligomers to produce a fuel that can be blended with a fossil fuel at a fossil fuel production facility 80.

The hydrocarbons 30 may have a product distribution in the range of C5 to C12 molecules typical of gasoline blendstocks. For example, 70-90% of the stream comprising the hydrocarbons 30 may include C5 and higher carbon number, with the remaining including benzene, toluene, ethyl benzene and/or xylenes and methane (C1). However, these product distributions can vary depending on the operating conditions of the catalytic reactor 20 and choice of catalyst. The hydrocarbon stream 30 also comprises light gases, such as methane, and optionally water. The hydrocarbon stream 30 in this example is cooled to ambient and fed to a separator 35, which in this non-limiting example is a 3-phase separator. In this example, water 70 is drawn from the bottom of the 3-phase separator 35 and a high carbon number fraction 50 comprising hydrocarbons, such as those in the C5 to C12 range, is withdrawn from a mid-region thereof. In addition, a low carbon number fraction 40 comprising the light gases is withdrawn from a top-region of separator 35.

The low carbon number fraction 40 from the 3-phase separator 35 is sent to a purification unit 45, such as a scrubber to remove any impurities therein and provide a purified methane 48. In this embodiment, the low carbon number fraction 40 comprises methane and thus the purified methane 48 may be introduced to a pipeline for transport to a fossil fuel production facility 80. The purified methane 48 may also be trucked to the fossil fuel production facility 80. The purified methane 48, which is renewable, can be fed and/or allocated to steam methane reformer (SMR) unit 60 in which the methane 48 is converted to hydrogen 62 according to the following reaction:

CH₄+H₂O+heat⇄CO+3H₂ (Eq. 1).

A water-gas shift reaction may be carried out as follows to obtain additional hydrogen:

CO+H₂O⇄CO₂+H₂+small amount of heat (Eq. 2).

When the SMR is separate from the fossil fuel production facility, the hydrogen 62 is subsequently fed and/or allocated to the fossil fuel production facility 80 (e.g., the renewable hydrogen may be transferred to the fossil fuel production facility as a fungible batch). As described, the hydrogen 62 may be fed and/or allocated to any hydroprocessing unit in such facility 80, including, for example, a hydrotreatment and/or hydrocracking unit. Supplying hydrogen to a hydroprocessing unit enables the production of a fuel 81 from the fossil fuel production facility 80 that is partially renewable.

The steam methane reforming produces carbon dioxide 66 as a byproduct in the water-gas shift reaction shown above and/or from combustion of fuel gas to produce heat for the steam methane reforming. Optionally, at least part of the CO₂ 66 from the steam methane reforming (SMR) unit 60 is captured and sequestered underground. Alternatively, or additionally, the captured CO₂ may be used in cement production. Such sequestration processes may further improve the lifecycle GHG emissions of a fuel produced by the process described herein.

The high carbon number fraction 50 from the 3-phase separator 35 comprising C5 to C12 hydrocarbons is optionally also fed to the fossil fuel production facility 80 and blended in an appropriate unit therein for further refining and/or upgrading (e.g., by hydrocracking and/or hydrotreating). The high carbon number fraction 50 is additionally or alternatively blended with a fuel product produced by the fossil fuel production facility 80. These latter steps of feeding a high carbon number fraction 50 to the fuel production facility 80 and/or blending with a fuel product are optional, but are advantageous in that they can increase the yield of the partially renewable fuel 81 further from the facility 80.

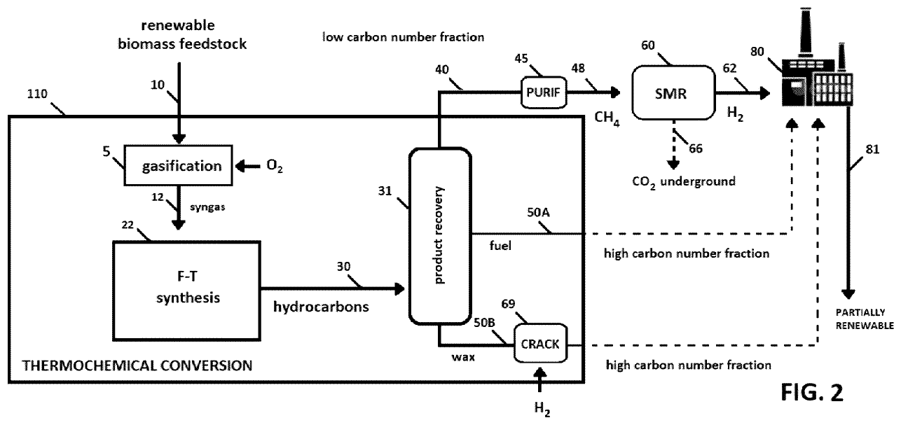

FIG. 2 shows a thermochemical conversion process 110 in which a renewable biomass feedstock 10 is gasified and the resultant syngas converted to hydrocarbons 30 in a Fischer Tropsch (F-T) synthesis unit 22. Like reference numbers depict the same or similar process steps and unit operations as those depicted in FIG. 1. Similar to FIG. 1, the process depicted in FIG. 2 shows a low carbon number fraction 40 comprising methane produced in a separation step (i.e., product recovery 31) of the thermochemical conversion process 110. The low carbon number fraction 40 is optionally purified in purification unit 45 and converted to hydrogen 62 for use in a fossil fuel production facility 80 to increase a renewable yield from the facility thereof.

In the process of FIG. 2, the renewable biomass feedstock 10 is subjected to a step of gasification in gasification unit 5 at elevated temperature with oxygen addition to produce syngas 12 comprising carbon monoxide, hydrogen and optionally carbon dioxide. Gasification is conducted under conditions known to those of skill in the art to produce the syngas 12.

The syngas 12 is fed to the F-T synthesis unit 22 to produce the hydrocarbons 30 according to the following equation:

(2n+1)H₂+n CO→CₙH₍₂ₙ₊₂₎+n H₂O (Eq. 6).

The FT synthesis in unit 22 is operated at elevated temperatures (e.g., 300-700 degrees Celsius) and uses a suitable catalyst, such as a transition metal of Group VIII. The reactor used in the FT synthesis unit 22 may be a fixed bed reactor, a fluidized bed reactor or a slurry bed reactor. Nickel catalysts may favour methane production and therefore, if desired, nickel could be used to promote methane production in addition to the production of higher carbon number hydrocarbons. Other metals that may be used in the F-T synthesis unit 22 include iron, ruthenium and cobalt.

The hydrocarbons 30 from F-T synthesis unit 22 are fed to a separator depicted here as a product recovery unit 31. The product recovery unit 31 may be a vapour-liquid separator or other unit that separates hydrocarbons based on molecular weight. In the product recovery unit 31, the hydrocarbon stream 30 is separated into a first high carbon number fraction 50A (e.g., naphtha and/or diesel), a second high carbon number fraction 50B, which is a wax bottom product, and the low carbon number fraction 40. The second high carbon number fraction 50B comprising the wax bottom product is optionally cracked in a cracking unit 69 to make smaller hydrocarbon molecules (with hydrogen addition) to produce an upgraded fuel product from the fraction 50B that is optionally sent to the fossil fuel production facility 80 for blending with a fuel product therein and/or refined further in such facility 80. Similarly, the first high carbon number fraction 50A (e.g., comprising naphtha and/or diesel) is optionally sent to the fossil fuel production facility 80 for blending with a fuel product and/or further refined therein.

The low carbon number fraction 40 from product recovery 31 comprises methane and other light hydrocarbons and is sent to an optional purification unit 45, such as a scrubber, to remove any impurities. The resultant purified low carbon number fraction 48 comprises methane and thus may be introduced to a pipeline for transport to the fossil fuel production facility 80. Since the pipeline is fungible, the methane withdrawn need not contain the same methane molecules as those fed to the pipeline originating from the renewable biomass feedstock 10 to be considered renewable by a regulator. The methane 48 may also be trucked to the fossil fuel production facility 80.

At the fossil fuel production facility 80, or at an off-site location, the purified methane 48 is sent to steam methane reformer (SMR) unit 60 in which the methane is converted to hydrogen 62 by steam reforming and a water-gas shift reaction (see above equations provided in connection with FIG. 1). The hydrogen 62 is fed to and/or allocated within the fossil fuel production facility 80 to produce a fuel that is at least partially renewable. As described, the hydrogen may be supplied to any hydroprocessing unit in such facility 80, thereby producing a fuel that is at least partially renewable.

Optionally, a CO₂ stream 66 obtained from the steam methane reforming unit 60 (e.g., produced in the water-gas shift) is sequestered underground. Alternatively, or additionally, the CO₂ may be used in cement production. Such sequestration processes may further improve the GHG emissions profile of a fuel produced by the process described herein.

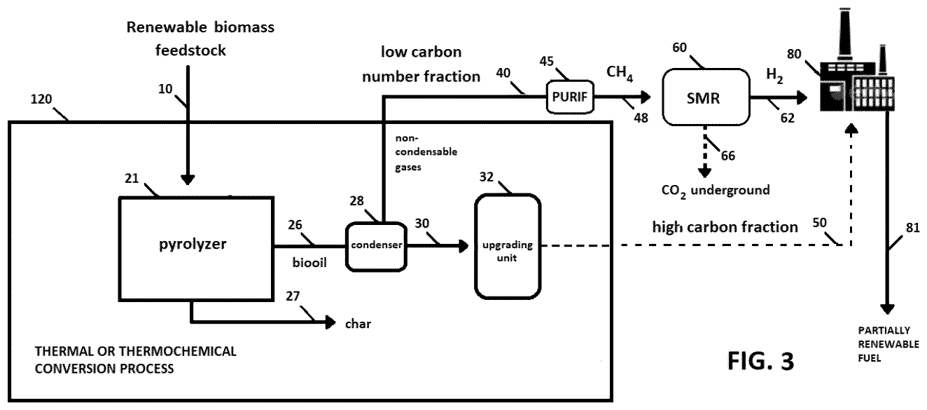

FIG. 3 shows a thermal or thermochemical conversion process 120 comprising pyrolysis to produce biooil 26. Like reference numbers depict the same or similar process steps or unit operations as those depicted in FIG. 1 and FIG. 2 described above. In this embodiment, a renewable biomass feedstock 10 is fed to a thermal conversion process 120, although the process may be considered a thermochemical conversion process if a catalyst is used in the pyrolyzer unit 21.

In the thermal conversion 120 depicted, the renewable biomass feedstock is fed to the pyrolyzer unit 21, in which thermal degradation occurs to produce biooil 26, char 27 and a low carbon number fraction 40. As would be appreciated by those of skill in the art, the renewable biomass feedstock may be dried or subjected to other optional processing steps, such as particle size reduction, prior to its introduction to the pyrolyzer unit 21.

The pyrolyzer unit 21 is operated under elevated temperature conditions, typically in a range of about 200-800 degrees Celsius and in the absence of oxygen or under low oxygen conditions. The biooil, ultimately making up at least a portion of the high carbon number fraction 50, is condensed in a condenser unit 28 and sent to an upgrading unit 32, while the non-condensable gases, which include CO, CO₂, H₂ and light hydrocarbon gases, such as CH₄, C₂H₆ and C₂H₄ are sent to purification unit 45 as the low carbon number fraction 40 to remove unwanted gases. A remaining solid char 27 from the pyrolyzer unit 21 is removed therefrom and may be used for heat generation or used as a replacement for coal.

The low carbon number fraction 40 is sent to a purification unit 45 to obtain purified methane 48. Such purification carried out in unit 45 may include scrubbing or other known processes to remove unwanted components. The purified methane 48 may be introduced to a pipeline that carries natural gas. The purified methane 48 may also be trucked to the fossil fuel production facility 80. Methane is withdrawn at the fossil fuel production facility 80 and is subsequently fed to steam methane reforming (SMR) 60 to produce hydrogen at the facility 80 or the hydrogen is produced by the SMR 60 at an off-site location. Since the pipeline is fungible, the methane withdrawn need not contain the same methane molecules as those fed to the pipeline originating from the renewable biomass feedstock 10 to be considered renewable by a regulator. The hydrogen 62 from SMR 60 is subsequently used in the fossil fuel production facility 80 in one or more steps to produce an at least partially renewable fuel 81.

Optionally, at least some of the CO₂ 66 from the steam methane reforming is sequestered underground. Alternatively, or additionally, the CO₂ may be used in cement production. Such sequestration processes may further improve the lifecycle GHG emissions profile of the process described herein.

The biooil 26 from condenser 28 may be upgraded in an upgrading unit 32 to make a fuel, such as diesel, gasoline, kerosene, methane or liquid petroleum gas (LPG). Such upgrading can include deoxygenation and/or refining, which can be carried out by hydrodeoxygenation using methods known to those of skill in the art. Alternatively, the upgrading unit 32 is omitted and is integrated in the pyrolyzer 21 itself by employing a suitable catalyst as part of a catalytic pyrolysis in the pyrolyzer 21. The fuel thus produced forms a high carbon number fraction 50 that is optionally sent to the fossil fuel production facility 80 for blending with a fuel produced in the facility 80. Carrying out this optional step of blending the high carbon number fraction 50 with a fuel produced in the fossil fuel production facility 80 further increases the yield of partially renewable fuel 81 produced by the facility 80.

Furthermore, upgrading in the pyrolyzer 21 itself or in the separate upgrading unit 32 need not be complete. A partially upgraded, high carbon number fraction 50 may be sent to the fossil fuel production facility 80 to complete upgrading of the biooil 26 therein. For example, such partially upgraded high carbon number fraction 50 could be combined with a fossil derived material in the fossil fuel production facility 80 and upgraded therein to produce the partially renewable fuel 81.

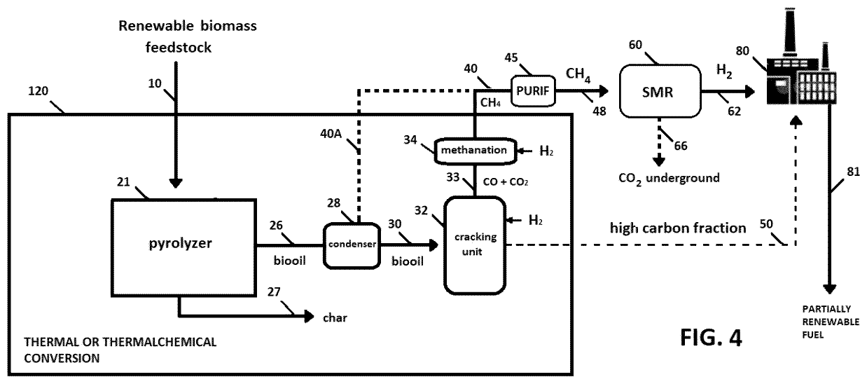

FIG. 4 shows a thermal or thermochemical conversion process 120 comprising pyrolysis to produce biooil 26. Like reference numbers depict the same or similar steps or unit operations as those described in FIGS. 1, 2 and 3 above. Similar to FIG. 3, in this embodiment, a renewable biomass feedstock 10 is fed to a thermal conversion 120 comprising a pyrolyzer 21, in which thermal degradation occurs to produce biooil 26, char 27 and a low carbon number fraction 40 comprising non-condensable gases.

The pyrolyzer unit 21 in FIG. 4 is operated under elevated temperature conditions (as described in connection with FIG. 3 above) to produce a crude biooil 26, which is condensed in a condenser unit 28 and sent to an upgrading unit 28, while the non-condensable gases, which includes CO, CO₂, H₂ and light hydrocarbon gases, such as CH₄, C₂H₆ and C₂H₄ are optionally sent to purification unit 45 as a low carbon number fraction 40A to remove unwanted gases. A remaining solid char 27 is removed from the pyrolyzer and may be used for heat generation or used as a replacement for coal.

In this example, condensed biooil 30 that exits the condenser 28 is fed to an upgrading unit 32, such as a catalytic cracking unit. The upgrading unit 32 upgrades the condensed biooil 30 by splitting the hydrocarbons therein to smaller molecules. A flue gas 33 comprising CO+CO₂ is produced that is often considered a waste gas. However, in this embodiment, the flue gas 33 comprising CO+CO₂ is subjected to methanation 34 with hydrogen addition to produce methane that is the low carbon number fraction 40 sent to purification 45 and steam methane reforming 60. A fuel produced by cracking the biooil 30 is the high carbon number fraction 50 that is optionally sent to the fuel production facility 80.

The purified methane 48 from purification unit 45 may be introduced to a pipeline that carries natural gas. The pipeline is fungible and so methane withdrawn therefrom is considered renewable by regulators. The methane 48 may also be trucked to the fossil fuel production facility 80. Methane is withdrawn at the fossil fuel production facility 80 and is subsequently fed to the steam methane reforming (SMR) 60 to produce hydrogen 62 or is produced off-site therefrom. The hydrogen 62 from SMR 60 is subsequently used in the fossil fuel production facility 80 in one or more steps to produce an at least partially renewable fuel 81.

The fuel thus produced forms a high carbon number fraction 50 that is optionally sent to the fossil fuel production facility 80 for blending with a fuel produced in the facility 80 to further improve the yield of partially renewable fuel therefrom.

Advantageously, since at least a portion of the low carbon number fraction resulting from the thermal or thermochemical conversion process (e.g., 100, 110, or 120) is used as a feedstock for hydrogen production and/or a feedstock for another fuel production facility that includes hydrogen production, the yield of renewable and/or partially renewable fuel produced from the renewable feedstock can be increased (e.g., relative to using the low carbon number fraction for heat and/or power generation).

Of course, the above embodiments have been provided as examples only. It will be appreciated by those of ordinary skill in the art that various modifications, alternate configurations, and/or equivalents will be employed without departing from the scope of the invention. Accordingly, the scope of the invention is therefore intended to be limited solely by the scope of the appended claims.

1. A method for producing a fuel that has renewable content, the method comprising:
providing renewable hydrogen, the renewable hydrogen sourced at least partially from causing renewable methane from a low carbon number fraction resulting from a conversion process to be fed, or co-fed with fossil material, to a hydrogen production unit to produce the renewable hydrogen,
wherein a feed to the conversion process is a carbon-containing renewable feedstock,
wherein the low carbon number fraction comprises carbon-containing molecules having 3 carbon atoms or less, and
wherein the conversion process from which the renewable hydrogen is sourced comprises a separation that fractionates the low carbon number fraction from a high carbon number fraction comprising carbon-containing molecules having 3 carbon atoms or more; and
using the renewable hydrogen as feedstock at a fossil fuel production facility to produce the fuel that has renewable content.

2. The method of claim 1, wherein the hydrogen production unit is located at the fossil fuel production facility.

3. The method of claim 1, wherein the conversion process from which the hydrogen is sourced uses bio-methane, bio-oil, bio-ethanol and/or biomass as a feedstock.

4. The method of claim 1, further comprising sourcing the high carbon number fraction and blending and/or reacting the high carbon number fraction with fossil derived material in the fossil fuel production facility.

5. The method of claim 4, wherein the fossil derived material is a liquid fuel.

6. The method of claim 1, further comprising collecting and sequestering carbon dioxide produced during production of the hydrogen from the hydrogen production unit.

7. The method of claim 1, wherein the low carbon number fraction from which the hydrogen is sourced comprises one or more hydrocarbons having 2 or less carbon atoms.

8. The method of claim 1, wherein the low carbon number fraction from which the hydrogen is sourced is a light end fraction from a column separator that separates the high and low carbon number fractions based on differences in boiling points.

9. The method of claim 8, wherein the low carbon number fraction from which the hydrogen is sourced is a fraction that is non-condensable during the separation using the column separator and is recovered from a top portion of the column separator.

10. The method of claim 9, wherein the column separator is a distillation, stripping or scrubbing column.

11. The method of claim 1, wherein the high carbon number fraction comprises C5 to C22 carbon-containing molecules.

12. The method of claim 11, wherein the high carbon number fraction comprises C5 to C12 carbon-containing molecules for gasoline production.

13. The method of claim 11, wherein the high carbon number fraction comprises C7 to C16 carbon-containing molecules for jet fuel.

14. The method of claim 11, wherein the high carbon number fraction comprises C10 to C20 carbon-containing molecules for diesel.

15. A method for producing a low carbon number fraction for use in a fuel production facility to produce a fuel that has renewable content, the method comprising:
conducting a conversion process that uses a carbon-containing renewable feedstock as a feed to the process, the conversion process comprising a separation that fractionates the low carbon number fraction comprising carbon-containing molecules having 3 carbon atoms or less from a high carbon number fraction comprising carbon-containing molecules having 3 carbon atoms or more;
providing the low carbon number fraction resulting from the separation to a hydrogen
production unit to be fed, or co-fed with fossil material, to produce renewable hydrogen; and
providing the renewable hydrogen to at least part of a fossil fuel production facility to supply hydrogen thereto and produce the fuel that has renewable content.

16. The method of claim 15, wherein the hydrogen production unit is located at the fossil fuel production facility.

17. The method of claim 15, wherein the conversion process from which the hydrogen is sourced uses bio-methane, bio-oil, bio-ethanol and/or biomass as the carbon-containing renewable feedstock.

18-20. (canceled)

21. The method of claim 15, wherein the low carbon number fraction comprises one or more hydrocarbons having 3 or less carbon atoms.

22-28. (canceled)

29. A method of producing fuel having renewable content from organic material, the method comprising:
converting at least part of the organic material to fuel in a first fuel production process, the first fuel production process including a separation that produces at least a low carbon number fraction and a high carbon number fraction, wherein the fuel produced from the first fuel production process is an at least partially renewable liquid fuel comprising or derived from the high carbon number fraction, the high carbon number fraction comprising hydrocarbons having at least three carbons; and
converting at least another part of the organic material to fuel in a second fuel production process, the second fuel production process comprising using hydrogen derived from the organic matter for the hydroprocessing of a feed not derived from the organic matter, wherein the hydrogen derived from the organic matter is produced in a process comprising feeding at least part of the low carbon number fraction and fossil based natural gas to hydrogen production, the low carbon number fraction comprising hydrocarbons having less than three carbons.

30-33. (canceled)

34. A method for producing fuel that has renewable content, the method comprising:
a) providing carbon-containing renewable feedstock for a first fuel production process, the carbon-containing renewable feedstock comprising carbon-containing molecules having 3 carbon atoms or less, the first fuel production process comprising a separation that separates a low carbon number fraction from a high carbon number fraction, the first fuel production process producing a first fuel or fuel intermediate that comprises or is derived from the high carbon number fraction;
b) providing hydrogen produced from a hydrogen production unit, wherein a feedstock for the hydrogen production comprises at least part of the low carbon number fraction; and
c) producing a second fuel from a second fuel production process, the second fuel production process comprising hydroprocessing crude oil derived liquid hydrocarbon using hydrogen produced in step b), thereby hydrogenating the crude oil derived liquid hydrocarbon and producing a partially renewable fuel or fuel intermediate,
wherein the first fuel or fuel intermediate is combined with at least one of (i) the crude oil derived liquid hydrocarbon prior to the hydroprocessing, (ii) the partially renewable fuel or fuel intermediate, or (iii) the second fuel, wherein second fuel comprises or is derived from the partially renewable fuel or fuel intermediate.
